(19) United States
(12) Patent Application Publication
(10) Pub. No.: US 2001/0024714 A1
(43) Pub. Date: Sep. 27, 2001

(54) FILM FOR DECORATIVE SHEET AND DECORATIVE SHEET USING THE SAME

(76) Inventors: KAZUYA HORI, AICHI (JP); KEN FURUYA, AICHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/210,763

(22) Filed: Dec. 14, 1998

(30) Foreign Application Priority Data
Dec. 15, 1997 (JP) PHEI-9-344997

(51) Int. Cl. B32B 27/32; B32B 3/00

(52) U.S. Cl. 428/220; 428/343; 428/206; 428/207; 525/240

(57) ABSTRACT

A film for a decorative sheet comprising: (A) a polypropylene resin having a melt flow rate of 0.1 to 50 g/10 min, a heat of crystal fusion of 30 to 140 J/g, and a flexural modulus of 1000 to 20,000 kg/cm²; and (B) an ethylene copolymer resin obtained by copolymerization in the presence of a metallocene catalyst, the ethylene copolymer comprising ethylene and an α-olefin having 3 to 12 carbon atoms and having a density of 0.86 to 0.92 g/cm³, a melt flow rate of 0.1 to 30, and a ratio of its weight-average molecular weight (Mw) to its number-average molecular weight ratio (Mn), Mw/Mn, of 1 to 5, the weight ratio of component (A) to component (B) being from 99/1 to 50/50. Also disclosed are a decorative sheet and a decorative material each comprising the film.

### FIELD OF THE INVENTION

This invention relates to a plastic decorative sheet for decorative materials, such as a plastic decorative laminate and a plastic-coated steel plate, which are used for furniture, constructional interior materials, and the like.

### BACKGROUND OF THE INVENTION

Decorative materials such as plastic decorative laminates are generally composed of a substrate, such as plywood or steel, overlaid with a decorative sheet having a single printed and/or colored film or a laminate thereof. The laminate type decorative sheet usually comprises a transparent surface layer and a printed and/or colored layer, which are bonded together via an adhesive layer.

Vinyl chloride resins have been used widely as a base resin of these decorative sheets for their excellent design properties and adhesion but have recently been being replaced with polyolefin resins from considerations of hydrogen chloride gas by-produced in thermal disposal after use and the material of incinerators. In particular, polypropylene resins have been extending their use as a base resin of a decorative sheet because of their satisfactory balance between rigidity and flexibility.

Decorative sheets generally employed are constituted by a transparent surface layer and a printed and/or colored layer, and these layers are laminated via an adhesive layer. Upon use of such a decorative sheet, a substrate such as plywood is laminated thereon via an adhesive layer coated or laminated on the back Bide of the decorative sheet (the side opposite to the transparent surface layer).

Depending on the cases, it is required that a decorative sheet be adhered to a substrate having a bending portion. When adhered to such a substrate, a decorative sheet tends to whiten at the bending portion to change its color or pattern, resulting in deteriorated appearance.

In order to prevent whitening upon bending, a synthetic resin having rubbery elasticity could be blended with a base resin. However, such a synthetic resin has poor compatibility with a polypropylene resin to provide a film with reduced strength. When such a film used as a decorative sheet is peeled off the substrate after use, it cannot be appropriately separated at the interface with the substrate over the entire surface thereof. That is, the polypropylene resin layer in the decorative sheet is broken at the peeling, and some parts of the decorative sheet remain on the substrate surface.

### SUMMARY OF THE INVENTION

Accordingly, an object of the present invention is to provide a polyolefin-based film for a decorative sheet which is free from the above-described disadvantages, i.e., a film which hardly undergoes whitening upon bending and can be peeled without destruction.

Another object of the present invention is to provide a decorative sheet and a decorative material each comprising the film.

Other objects and effects of the present invention will become apparent from the following description.

The above described objects of the present invention have been achieved by providing the following films, decorative sheets and decorative materials.

1) A film for a decorative sheet comprising

(A) a polypropylene resin having a melt flow rate of 0.1 to 50 g/10 min, a heat of crystal fusion of 30 to 140 J/g, and a flexural modulus of 1000 to 20,000 kg/cm²; and

(B) an ethylene copolymer resin obtained by copolymerization in the presence of a metallocene catalyst, the ethylene copolymer comprising ethylene and an α-olefin having 3 to 12 carbon atoms, and having a density of 0.86 to 0.92 g/cm³, a melt flow rate of 0.1 to 30, and a ratio of its weight-average molecular weight (Mw) to its number-average molecular weight ratio (Mn), Mw/Mn, of 1 to 5,

the weight ratio of component (A) to component (B) being from 99/1 to 50/50.

2) The film according to the above 1), which has a thickness of from 0.03 to 2 mm.

3) The film according to the above 1), wherein the polypropylene resin is a mixture of two or more kinds of polypropylene resins having different heats of crystal fusion.

4) The film according to the above 1), wherein the polypropylene resin is a mixture of two or more kinds of polypropylene resins having different crystal fusion temperatures.

5) A decorative sheet which comprises a film according to any one of the above 1) to 4), one surface of the film being printed.

6) A decorative sheet which comprises a film according to any one of the above 1) to 4), the film being colored.

7) A decorative sheet which comprises a film according to any one of the above 1) to 4) having successively provided thereon an adhesive layer and a surface layer, the film being colored or one surface of the film being printed.

8) A decorative material which comprises a decorative sheet according to the above 5) having successively provided thereon an adhesive layer and a substrate.

9) A decorative material which comprises a decorative sheet according to the above 6) having successively provided thereon an adhesive layer and a substrate.

10) A decorative material which comprises a decorative sheet according to the above 7) having successively provided, on the side thereof opposite to the surface layer, an adhesive layer and a substrate.

The film according to the present invention provides a decorative sheet which hardly undergoes whitening upon bending, has broad processing latitude, and, after use, can be removed with little cohesive failure occurring in the film. Therefore, the film is particularly suitable for use in a decorative sheet.

### DETAILED DESCRIPTION OF THE INVENTION

The film for a decorative sheet according to the present-invention comprises a mixture of (A) a specific polypropylene resin and (B) a specific polyethylene resin.

The polypropylene resin for use in the present invention as component (A) includes a propylene homopolymer, copolymers mainly comprising propylene, and a mixture of two or more thereof. Random copolymers comprising propylene and at least one olefinic comonomer selected from ethylene and an α-olefin having 4 to 12 carbon atoms are preferred. The α-olefin includes butene-1, pentene-1₁ hexene-l, octene-1, decene-1, and dodecene-l. If the number of the carbon atoms of the α-olefin comonomer exceeds 12, random copolymerizability of the α-olefin tends to reduce.

In the above-mentioned random copolymer, the olefinic comonomer units are arranged irregularly to disturb the stereoregularity, i.e., to decrease the crystallinity of the polymer thereby to provide a-transparent and flexible polymer. The content of the olefinic comonomer unit in the random copolymer is preferably 1 to 10% by weight, still preferably 2 to 6% by weight.

Besides the above-mentioned propylene random copolymer, a propylene homopolymer, a propylene copolymer, such as an ethylene-propylene block copolymer, and a mixture of two or more of such polypropylene resins can be used without any problems so long an the resulting polypropylene resin (A) has an MPR, a heat of crystal fusion, and a flexural modulus each falling within the respective specific ranges described below.

The polypropylene resin for use in the present invention should have an MPR of from 0.1 to 50 gil min. If the MFR is less than 0.1 g/10 min, the resin is difficult to mold to obtain a smooth film. If it exceeds 50 g/10 min, the melt viscosity of the resin is too low to obtain a film.

The polypropylene resin should have a heat of crystal fusion of from 30 to 140 J/g and a flexural modulus of from 1000 to 20,000 kg/cm². A preferred heat of crystal fusion is from 80 to 120 J/g, and a preferred flexural modulus is from 8000 to 15,000 kg/cm².

If the heat of crystal fusion is less than 30 J/g, or if the flexural modulus is less than 1000 kg/cm², the resulting film is too soft for processing for use as a film for a decorative sheet. If, on the other hand, the heat of crystal fusion is more than 140 J/g, or if the flexural modulus is more than 20,000 kg/cm², the resulting. film has reduced transparency or undergoes considerable whitening upon bending, especially at low temperatures, e.g., 0° C.

The terminology “heat of crystal fusion” as used herein denotes a value calculated from the crystalline peak area of the DSC (differential scanning calorimeter) chart obtained by once melting a resin above its melting point and then cooling at a rate of 10° C./min.

The ethylene copolymer resin for use in the present invention as component (B) is obtained by copolymerizing ethylene and an α-olefin having from 3 to 12 carbon atoms in the presence of a metallocene catalyst.

The metallocene catalyst (also called a single site catalyst or a Kaminsky catalyst) comprises a metallocene transition metal complex and an organoaluminum compound, as described in JP-A-3-163080 (the term “JP-A” as used herein means an “unexamined published Japanese patent application”), JP-A-7-118431, and JP-A-7-148895. The metallocene catalyst is sometimes used as supported on an inorganic carrier.

The metallocens transition metal complex includes a compound of a transition metal of the group IVB (i.e., titanium, zirconium or hafnium) having coordinated thereto one or two ligands selected from a substituted or unsubstituted cyclopentadienyl group, a substituted or unsubstituted dicyclopentadienyl group, a substituted or unsubstituted indenyl group, a substituted or unsubstituted tetrahydroindenyl group, and a substituted or unsubstituted fluonyl group, in which two ligands may be crosslinked via a covalent bond, and which may further have coordinated thereto a hydrogen atom, an oxygen atom, a halogen atom, an alkyl group, an alkoxy group, an aryl group, an acetylacetonato group, etc. as a ligand.

The organoaluminum compound includes an alkylaluminum and an acyclic or cyclic aluminoxane. Examples of the alkylaluminum are triethylaluminum, triisobutylaluminum, dimethylaluminum chloride, diethylaluminum chloride, methylaluminum dichloride, ethylaluminum dichloride, dimethylaluminum fluoride, duisobutylaluminum hydride, diethylaluminum hydride, and ethylaluminum sesquichloride. The acyclic or cyclic aluminoxane can be produced by contacting the alkylaluminum with water. For example, it is obtained by adding an alkylaluminum to the polymerization system and then adding thereto water, or by reacting an alkylaluminum with water of crystallization of a complex salt or with absorbed water of an organic or inorganic compound.

The carrier on which the metallocene catalyst can be supported includes silica gel, zeolite, and diatomaceous earth.

The α-olefin having from 3 to 12 carbon atoms that is copolymerized with ethylene includes propylene, 1-butene, 1-pentene, 1-hexene, 1-heptene, 1-octene, 4-methyl-1-pentene, and 1-decene. These α-olefins can be used either individually or as a mixture of two or more thereof. The α-olefin for use herein is preferably used in an amount of from 5 to 40% by weight based on the weight of ethylene in component (B).

The ethylene copolymer prepared by using the above-described metallocene catalyst is superior in flexibility and mechanical strength as compared to other polyethylene resins obtained by using a Ziegler catalyst, a solid catalyst, etc.

The ethylene copolymer as component (B) has a density of from 0.86 to 0.92 g/cm³, preferably from 0.86 to 0.90 g/cm³, an MFR of from 0.1 to 30 g/10 min, preferably from 0.5 to 5 g/10 min, and a ratio of its weight-average molecular weight (Kw) to its number-average molecular weight (Mn), Mw/Mn obtained by gel-permeation chromatography (GPC) of 1 to 5.

The weight ratio of the polypropylene resin (A) and the ethylene copolymer resin (B) is 99/1 to 50/50.

If any of the above physical properties of the ethylene copolymer is out of the above specific range, the resulting film has deteriorated stress-strain characteristics, and the processability is reduced, or the film becomes brittle due to insufficient strength.

Polyethylene resins other than those obtained by using a metallocene catalyst can also be contained as far as the effects of the present invention are not impaired. In this case, the weight ratio of the polypropylene resin to the total polyethylene resin (those obtained by using a metallocene catalyst and other polyethylene resins) should be within the range of from 99/1 to 50/50. If the weight ratio of the polypropylene resin is out of, the above range, the resulting film tends to undergo whitening upon bending, has narrow processing latitude, or has reduced strength.

As for the stress-strain characteristics, the film of the present invention preferably has a yield elongation in tension of 15 to 30%. If the yield elongation in tension is out of this range, the film tends to show a clear yield value, i.e., tends to undergo whitening, or the suitable range of processing temperature tends to be narrowed.

It is preferred to use two or more polypropylene resins different in heat of crystal fusion as component (A) to obtain further improved resistance to whitening upon bending.

It is also preferred to use two or more polypropylene resins different in crystal fusion temperature an component (A) to improve temperature dependence and thereby to improve processability.

The terminology “crystal fusion temperature” as used herein denotes the peak temperature in the DSC (differential scanning calorimetry) chart (melting curve) obtained with a temperature increasing rate of 10° C./min.

The film for a decorative sheet preferably has a thickness of 0.03 to 2 mm. It is practically difficult to produce film of less thickness than 0.03 mm. A decorative sheet comprising a film having a thickness exceeding 2 mm tends to be difficult to adhere to a substrate at bending portions and end portions or tends to have poor texture.

The film of the present invention hardly suffers from whitening upon bending. Further, since the film has sufficient strength, hardly does it undergo cohesive failure when separated from the substrate after use. Accordingly, the film of the present invention is fit to use as a base layer of a laminate type decorative sheet. The film can also be printed and/or colored for use as, for example, a single-layered decorative sheet.

It is preferable for the film to contain an ultraviolet (UV) absorber and/or a light stabilizer. Suitable UV absorbers include benzotriazole UV absorbers, such as 2-[2′-hydroxy-3′-(3″,4″, 5″, 6″-tetrahydrophthalimidomethyl)-5′-methylphenyl ]benzotriazole, 2-[2-hydroxy-3,5-bis(α,α-dimethylbenzyl)phenyl]-2H-benzotriazole, and 2,2-methylenebis[4-(1,1,3,3-tetramethylbutyl-6-(2H-benzotriazol-2-yl) phenol]; and benzophenone UV absorbers, such as 2,4-dihydroxybenzophenone, 2-hydroxy-4-methoxybenzophenone, 2-hydroxy-4-octoxybenzophenone, 2,2′-dihydroxy-4-dimethoxybenzophenone, and bis(2-methoxy-4-hydroxy-5-benzoylphenyl)methane. Preferred of these are benzotriazole UV absorbers for minimizing coloring of the product.

Suitable light stabilizers include hindered amine light stabilizers.

If desired, the film can further contain various additives, such as antioxidant., slipping agents, coloring agents, fillers, and nucleating agents, an long as the effects of the present invention are not impaired.

The process for preparing the film in not particularly limited, and any film forming method known for polyolefins, ouch as T-die extrusion, blown film extrusion, and calendering, can be employed.

The film of the present invention can be printed and/or colored to provide a decorative sheet having a single layer structure. Printing of the film can be carried out by applying printing-ink onto the film surface by means of a coater, etc. In this case, the printing may be preceded, as needed, by a primer treatment onto the surface of the film to be printed. Coloring of the film can be effected by compounding the base resin with a coloring agent such as a dye or a pigment.

The film can also be used as a base layer of a laminate type decorative sheet. When used as a base layer, the film may be, as needed, printed and/or colored. The laminate type decorative sheet can be produced by applying a primer to one side of the film as needed, and then successively laminating thereon an adhesive layer and a surface layer, which may be the film of the present invention. The lamination can be carried out by co-extruding the constituent layers, contact or fusion bonding the constituent layers simultaneously with film molding, or bonding separately molded films by means of a laminator. The adhesive layer may be provided by applying a liquid or pasty adhesive to the film with a coater.

These sheets hardly undergo whitening upon bending or cohesive failure upon peeling and can be suitably used as a decorative sheet.

A decorative material can be produced by successively laminating an adhesive layer and a substrate on the resulting decorative sheet with or without a primer applied on the decorative sheet. The substrate includes wood, such as plywood, and a steel plate.

The present invention will now be illustrated in greater detail with reference to the following Examples, but the invention should not be construed as being limited thereto. Unless otherwise indicated, all the parts are given by weight.

### EXAMPLES 1TO 5 AND COMPARATIVE EXAMPLES 1 TO 4

Polyolefin resins shown in Tables 1 and 2 below were extruded from a T-die extruder (diameter: 40 mm; die width: 400 mm) at a die temperature of 2200° C. to obtain a transparent film having a thickness of 100 μm.

The resulting film was evaluated as described below. The results obtained are shown in Tables 1 and 2. In the Tables, “PP” and “PE” stand for polypropylene and polyethylene, respectively; “EP rubber” or “EPRI” means ethylene-propylene rubber; and “PE resin A” is an ethylene-octene-1 copolymer obtained by copolymerization using a metallocene catalyst.

1) MFR Measured in accordance with JIS K 6758 (and JIS K 7210).

2) Flexural Modulus Measured in accordance with JIS K 7203.

3) Yield Value and Yield Elongation in Tension Measured in accordance with JIS K 7127.

4) Peal Strength

Two sheets of the film (2 cm wide and 10 cm long) for evaluation were adhered using a two-part adhesive and peeled apart along the longitudinal direction at a pulling speed of 50 mm/min at a peel angle of 180°. The peel strength was autographically recorded.

5) Release Properties

The condition of the film after the above-described peeling test was observed with the naked eye, and the release properties of the film were evaluated as follows.

| | |
|---|---|
| A . . . | The adhesive layer shows cohesive failure. |
| B . . . | Part of the film shows cohesive failure. |
| C . . . | The film shows considerable cohesive failure. |

6) Resistance to Whitening upon Bending

The film was bent at 800° at a temperature of 0° C., and the degree of whitening at the bending portion was graded as follows.

| | |
|---|---|
| A . . . | No whitening was observed. |
| B . . . | Slight whitening was observed. |
| C . . . | Considerable whitening was observed. |

TABLE 1

| | | Example | | | | |
|---|---|---|---|---|---|---|
| | | 1 | 2 | 3 | 4 | 5 |
| PP | MFR | 15 | 15 | 15 | — | 15 |
| Resin | (g/10 | | | | | |
| A | min | | | | | |
| | Heat | | | | | |
| | of | | | | | |
| | Crys- | 120 | 120 | 120 | — | 120 |
| | tal | | | | | |
| | Fu- | | | | | |
| | sion | | | | | |
| | (J/g) | | | | | |
| | Flex- | 14000 | 14000 | 14000 | — | 14000 |
| | ural | | | | | |
| | Mod- | | | | | |
| | ulus | | | | | |
| | (kg/ | | | | | |
| | cm²) | | | | | |
| PP | MFR | — | 10 | 10 | 10 | 10 |
| Resin | (g/10 | | | | | |
| B | min) | | | | | |
| | Heat | — | 95 | 95 | 95 | 95 |
| | of | | | | | |
| | Crys- | | | | | |
| | tal | | | | | |
| | Fu- | | | | | |
| | sion | | | | | |
| | (J/g) | | | | | |
| | Flex- | — | 7000 | 7000 | 7000 | 7000 |
| | ural | | | | | |
| | Mod- | | | | | |
| | ulus | | | | | |
| | (kg/ | | | | | |
| | cm²) | | | | | |
| PE | Den- | 0.868 | 0.895 | 0.868 | 0.868 | 0.868 |
| Resin | sity | | | | | |
| A | (g/ | | | | | |
| | cm³) | | | | | |
| | MFR | 0.5 | 1.6 | 0.5 | 0.5 | 0.5 |
| | (g/10 | | | | | |
| | min) | | | | | |
| | Mw/ | 2.5 | 2.3 | 2.5 | 2.5 | 2.5 |
| | Mn | | | | | |
| PE | Den- | — | — | 0.918 | 0.918 | 0.918 |
| Resin | sity | | | | | |
| B | (g/ | | | | | |
| | cm³) | | | | | |
| | MFR | — | — | 14 | 14 | 14 |
| | (g/10 | | | | | |
| | min) | | | | | |
| | Mw/ | — | — | 7.2 | 7.2 | 7.2 |
| | Mn | | | | | |

| | | | | | |
|---|---|---|---|---|---|
| PPA/PPB/ | 85/0/ | 40/40/ | 40/40/ | 0/85/ | 40/40/ |
| PEA/PEB | 15/0 | 20/0 | 10/10 | 10/5 | 10/10 |
| Mixing Ratio | | | | | |
| Modulus of | 9000 | 9000 | 8500 | 6000 | 8500 |
| Elasticity | | | | | |
| (kg/cm²) | | | | | |
| Yield Value | 250 | 240 | 215 | 180 | 215 |
| (kg/cm³) | | | | | |
| Yield | 17.5 | 17.3 | 18.6 | 19.5 | 18.6 |
| Elongation | | | | | |
| in Tension | | | | | |
| (%) | | | | | |
| Release | A | A | A | A | A |
| Properties | | | | | |
| Peel Strength | 2100 | 2000 | 2500 | 2800 | 2500 |
| (g/cm) | | | | | |
| Resistance to | A | A | A | A | A |
| Whitening | | | | | |
| on Bending | | | | | |

TABLE 2

| | | Comparative Example | | | |
|---|---|---|---|---|---|
| | | 1 | 2 | 3 | 4 |
| PP | MFR (g/10 min) | 1.5 | 15 | 15 | 15 |
| Resin | Heat of Crystal | 120 | 120 | 120 | 120 |
| | Fusion (J/g) | | | | |
| | Flexural Modulus | 14000 | 14000 | 14000 | 14000 |
| | (kg/cm²) | | | | |
| PE | Density (g/cm²) | — | 0.918 | — | — |
| Resin | MFR (g/10 min) | — | 14 | — | — |
| | MW/Mn | — | 7.2 | — | — |
| EP | Density (g/cm³) | — | — | 0.88 | 0.87 |
| rubber | MFR (g/10 min) | — | — | 1.5 | 2.9 |

| | | | | |
|---|---|---|---|---|
| PP/PE/EPR Mixing Ratio | 100/0/0 | 80/20/0 | 80/0/20 | 80/0/20 |
| Modulus of Elasticity | 14000 | 11000 | 10000 | 10000 |
| (kg/cm) | | | | |
| Yield Value (kg/cm²) | 290 | 280 | 275 | 275 |
| Yield Elongation in | 14.0 | 16.6 | 16.5 | 16.7 |
| Tension (%) | | | | |
| Release Properties | A | C | C | B |
| Peel Strength (g/cm) | 2900 | 1200 | 1000 | 1500 |
| Resistance to Whitening | C | C | B | B |
| on Bending | | | | |

The film prepared in Examples and Comparative Examples was used an a base film for a decorative sheet. One side of the film was subjected to a corona treatment and coated with a primer mainly comprising a chlorinated polyolefin resin. Woodgrain was imparted to the thus pretreated film by gravure printing, and the same transparent film an the base film was adhered to the printed side, followed by embossing to prepare a decorative sheet. The back side of the decorative sheet was subjected to a corona treatment, and an adhesive was applied thereon. Plywood was adhered thereto to produce a decorative material.

Because the decorative sheets prepared by using the film of Examples exhibit excellent resistance to whitening upon bending, the decorative materials having these decorative sheets had a satisfactory appearance, suffering from no whitening at its edges. On the other hand, the decorative materials prepared by using the film of Comparative Examples were inferior in quality, suffering from whitening at edges of the plywood. Thus, the film for a decorative sheet according to the present invention was proved satisfactory in both resistance to whitening upon bending and release properties compared with the comparative films.

While the invention has been described in detail and with reference to specific examples thereof, it will be apparent to one skilled in the art that various changes and modifications can be made therein without departing from the spirit and scope thereof.

What is claimed is:

1. A film for a decorative sheet comprising;
(A) a polypropylene resin having a melt flow rate of 0.1 to 50 g/10 min, a heat of crystal fusion of 30 to 140 J/g, and a flexural modulus of 1000 to 20,000 kg/cm²; and
(B) an ethylene copolymer resin obtained by copolymerization in the presence of a metallocene catalyst, the ethylene copolymer comprising ethylene and an α-olefin having 3 to 12 carbon atoms, and having a density of 0.86 to 0.92 g/cm^{3,} a melt flow rate of 0.1 to 30, and a ratio of its weight-average molecular weight (Mw) to its number-average molecular weight ratio (Mn), Mw/M,n of 1 to 5,
the weight ratio of component (A) to component (B) being from 99/1 to 50/50.

2. The film according to claim 1, which has a thickness of from 0.03 to 2 mm.

3. The film according to claim 1, wherein the polypropylene resin is a mixture of two or more kinds of polypropylene resins having different heats of crystal fusion.

4. The film according to claim 1, wherein the polypropylene resin is a mixture of two or more kinds of polypropylene resins having different crystal fusion temperatures.

5. A decorative sheet which comprises a film according to claim 1, one surface of the film being printed.

6. A decorative sheet which comprises a film according to claim 1, the film being colored.

7. A decorative sheet which comprises a film according to claim 1 having successively provided thereon an adhesive layer and a surface layer, the film being colored or one surface of the film being printed.

8. A decorative material which comprises a decorative sheet according to claim 5 having successively provided thereon an adhesive layer and a substrate.

9. A decorative material which comprises a decorative sheet according to claim 6 having successively provided thereon an adhesive layer and a substrate.

10. A decorative material which comprises a decorative sheet according to claim 7 having successively provided, on the side thereof opposite to the surface layer, an adhesive layer and a substrate.
